(19) United States
(12) Patent Application Publication
(10) Pub. No.: US 2006/0250322 A1
(43) Pub. Date: Nov. 9, 2006

(54) Dynamic vergence and focus control for head-mounted displays

(75) Inventors: John M. Hall, Amherst, NH (US); David J. Herold, Hampstead, NH (US)

Correspondence Address: OPTICUS IP, 7791 ALISTER MACKENZIE DRIVE, SARASOTA, FL, 34240, US

(73) Assignee: OPTICS 1, INC.

(21) Appl. No.: 11/124,648

(22) Filed: May 9, 2005

(51) Int. Cl. G09G 5/00

(52) U.S. Cl. 345/8

(57) ABSTRACT

Systems and methods for dynamically controlling vergence and focus for a see-through head-mounted display (ST-HMD) used as part of an augmented reality (AR) system are disclosed. The ST-HMD (40) allows a user (30) to view left and right images (150L, 150R) through corresponding left and right eyepieces (104L, 104R) so that a single virtual object (150V) based on the right and left images as seen at a real object such as a screen (20). When the user moves relative to the real object, however, the vergence changes and the virtual object does not appear in focus at the real object. Changes in the vergence are compensated by tracking the user's head position with a tracking unit (350) and providing the tracking data to a controller (180). Based on the tracking data and the interpupilary distance (IPD) of the user, the controller calculates the offset (H) needed to be imparted to the images formed in the eyepieces to maintain the vergence of the virtual object at the real object even when the user's position changes relative to the real object.

### FIELD OF THE INVENTION

The present invention relates to head-mounted displays, and in particular relates to systems and methods for maintaining vergence and focus in such displays, such as when a user moves his head when viewing virtual objects in an augmented reality system.

### DESCRIPTION OF THE RELATED ART

Head-mounted displays allow a person to interact with or be immersed in an artificial or “virtual” environment, also called a “virtual reality” or “augmented reality.” Augmented reality (AR) is a technology in which a user's view of a real-world scene is enhanced or augmented with synthetically generated (i.e., non-real-world) information. In a typical AR system, a user wears a head-mounted display through which is viewed a real or projected environment (hereinafter, “real-world scene”). Computer-generated graphics are superimposed on the real-world scene by viewing the graphics (“virtual objects”) through the head mounted display such that the virtual objects and the real objects that make up the real world scene are visually aligned.

For an AR user to successfully interact with the real-world scene on an ongoing basis, the position and orientation of the virtual objects relative to the real objects must be tracked. This is typically accomplished by tracking the position of the head-mounted display so that real and virtual objects blend together to form a realistic augmented real-world scene.

In an AR system, the real and virtual objects must be accurately positioned relative to each other. This implies that certain measurements or calibrations, such as focus and head position, need to be made at system start-up. These calibrations may involve, for example, measuring the position and orientation of various AR system components such as trackers, pointers, cameras, etc. The calibration method in an AR system depends on the architecture of the particular system and the types of components used.

Modern flight simulator systems are one example of a type of AR system. A typical flight simulator system utilizes multiple image sources to generate real and virtual objects that are intended for simultaneous viewing by the user. FIG. 1 is a schematic plan view of a typical configuration for a flight simulator system 10 that includes an “Out the Window” (OTW) dome-shaped screen 20 on which a real-world scene, such as broad landscape scenery (not shown), is fixed to or otherwise imaged (e.g., projected) thereon. A user 30 is positioned at the center-of-curvature of the screen. User 30 wears a see-through head-mounted display (ST-HMD) 40. ST-HMD 40 is adapted to support images (not shown) to be viewed by the user; for example, computer-generated graphics of flight instrument readings, target reticles, or perhaps even images of moving targets.

One requirement of flight simulator system 10 is that the computer-generated graphics, i.e., the virtual objects, provided to ST-HMD 40 and viewed by user 30 when viewing screen 20 must match the imagery of the real-world scene as presented on OTW dome screen 20 in terms of both focus distance and eye vergence angle, or simply “vergence.” “Vergence” is defined as the angle θ subtended by the lines of sight 50L and 5OR of the respective left and right eyes (not shown) of the user focused on a real object 56 on screen 20. As the object distance D approaches infinity, the vergence approaches zero and the lines of sight become parallel, and the focus goes to infinity. As the object moves closer to the observer, however, the vergence increases trigonometrically, and the focus position moves closer to the observer.

In flight simulator system 10, as well as in other types of AR systems, it is necessary to preserve both focus and vergence. This is a relatively new phenomenon because only recently have ST-HMD's been considered for use in flight simulators. In many current and most past applications, the simulator relied on a single image screen for all of its imagery. Because this is an emerging technology, there has been only cursory investigation into the physiological effects of a vergence mismatch between the ST-HMD and OTW screen. It is certain, however, that vergence angles are processed by the brain and used in depth perception, and it is also well known that unnatural vergence angles will eventually inhibit the user's ability to perform binocular fusion. It may also be considered that vergence mismatch may play a role in the known problem of “symbology fixation”. This is where an aircraft pilot becomes so fixated on reading heads-up display symbology that he/she tends to ignore the view of the real world through the canopy window. Research in this area is still ongoing, but a vergence mismatch between the ST-HMD and the real-world scene may possibly contribute to symbology fixation.

### SUMMARY OF THE INVENTION

The present invention is directed to systems and methods for dynamically controlling vergence and focus for a see-through head-mounted display (ST-HMD) when viewing a real object, such as a screen, in an augmented reality (AR) system. The ST-HMD allows a user to view left and right images through corresponding left and right eyepieces so that a single registered virtual object based on the right and left images is seen at the real object. When the user moves relative to the real object, however, the vergence changes and the virtual object does not appear in focus at the real object. Changes in the vergence are compensated by tracking the user's head position (and/or eye position) and providing this tracking data to a controller. Based on the tracking data and the interpupilary distance (IPD) of the user, the controller calculates the offset needed to be imparted to the images formed in the eyepieces to maintain the vergence of the virtual object at the real object even when the user's position changes relative to the real object.

These and other aspects of the invention are discussed in greater detail below.

### BRIEF DESCRIPTION OF THE DRAWINGS

FIG. 1 is a schematic plan view of a typical AR system, showing a screen, an ST-HMD, and the user located at the center of curvature of the screen and wearing the ST-HMD;

FIG. 2 is a close-up face-on detailed view of an example embodiment of an ST-HMD according to the present invention, wherein the pixels of the FPDs are shown superimposed on the eyepieces to illustrate the shift in pixel location of the images as seen by the user wearing the ST-HMD;

FIG. 3 is a close-up detailed view of an example embodiment of one of the eyepieces of the ST-HMD;

FIG. 4 is a plan view of an FPD showing the addressable array of pixels, with pixel rows (146R) and pixel columns (146C);

FIG. 5A is front-on view of the screen as viewed by the user through the ST-HMD, showing the virtual object (150V) in the shape of a cross along with the landscape scenery formed on the screen, wherein the virtual object is formed by left and right eyepiece images (150L and 150R) provided to respective FPDs 140L and 140R by video electronics units (160L and 160R);

FIG. 5B is the same as FIG. 5A, but wherein the vergence is not corrected because the position of the user's head changed relative to the screen;

FIG. 6 is a plan schematic diagram of the eyepieces in the ST-HMD, illustrating the interpupilary distance (IPD), the eyepiece rotation angle φ and the vergence angle θ;

FIG. 7 is a schematic diagram illustrating the different parameters and vectors for the AR system of FIG. 1 used to determine the amount of image shift needed to correct for changes in vergence as the user moves his head relative to the screen;

FIG. 8 is a flow diagram of an example embodiment of a method of operation of ST-HMD system 40 as part of AR system 10 of FIG. 1, illustrating how vergence is corrected as the user moves his head to maintain the focus of the virtual object at the screen; and

FIG. 9 is the same as FIG. 3, but additionally including eye-tracker optics and a controller according to an optional example embodiment where tracking includes tracking movement of the user's eyes.

### DETAILED DESCRIPTION OF THE INVENTION

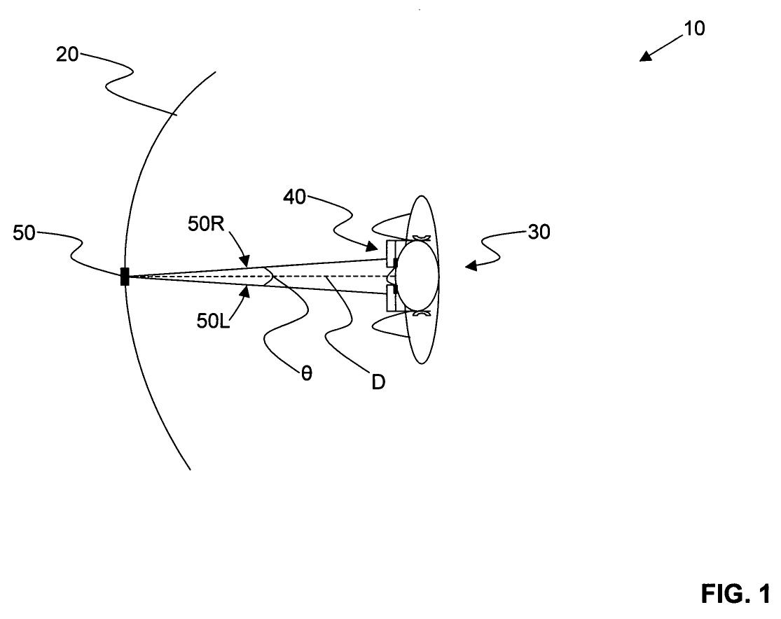

The present invention relates to AR systems such as that shown in FIG. 1, wherein the ST-HMD is adapted to make static and dynamic adjustments to achieve dynamic vergence and focus overlay while viewing a real object, such as a screen, at a distance from the user. Note that in the discussion below, a screen is used as an example of an object typically used in AR systems for the sake of illustration. While the present invention is aptly suited for viewing virtual objects on a screen, a screen is just one example of a real object. A screen also serves as a medium that supports a real image, such as landscape scenery, that serves as a real object for the user. The present invention is generally applicable to viewing virtual objects at the location of a real object while maintaining vergence and focus at the real object.

Preserving both focus and vergence for the user of the ST-HMD requires satisfying several conditions, namely:
1) matching the focus diopter setting of the ST-HMD to the screen distance such that the real-world scene and the virtual objects as viewed through the ST-HMD are in the same focus plane;
2) matching the vergence between the screen and ST-HMD for objects along the same line of sight; and
3) providing dynamic correction of focus and vergence based on the user's head position and direction of sight.

Satisfying these conditions is a complex undertaking because the ST-HMD moves with the user's head, whereas the dome screen is fixed in space. The methods and apparatus of the present invention as described below account for such movement and allow for the abovementioned conditions to be satisfied.

Apparatus

The apparatus of the present invention includes an AR system, and in particular, an ST-HMD system (“ST-HMD”) adapted to operate as part of an AR system in a manner that preserves both focus and vergence. The various elements of the ST-HMD system are described below.

ST-HMD Housing

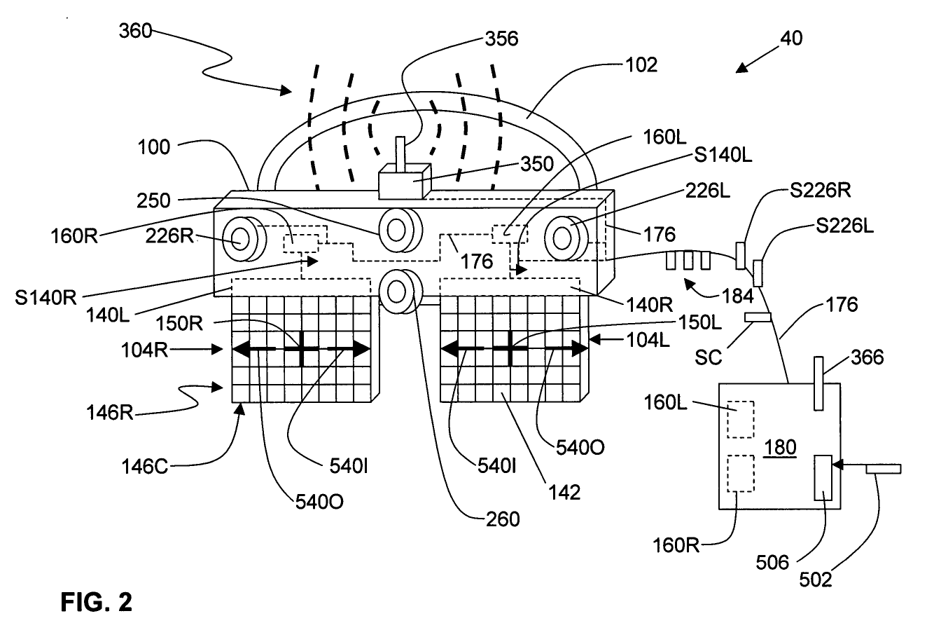

FIG. 2 is a close-up face-on detailed view of an example embodiment of an ST-HMD 40 according to the present invention as part of AR system 10 of FIG. 1. ST-HMD 40 includes a housing 100 with a lower surface 101. Housing 100 includes a head strap 102 that allows user 30 (FIG. 1) to keep the housing and eyepieces 104L and 104R (discussed below) properly situated relative to the user's head. Housing 100 can be one of the standard housings used for ST-HMDs.

Eyepieces

ST-HMD 40 includes left and right see-through left and right eyepieces 104L and 104R operably coupled with housing 100. When user 30 properly wears ST-HMD 40, housing 100 rests against the user's forehead so that the left and right eyepieces are positioned to generally align with the user's left and right eyes.

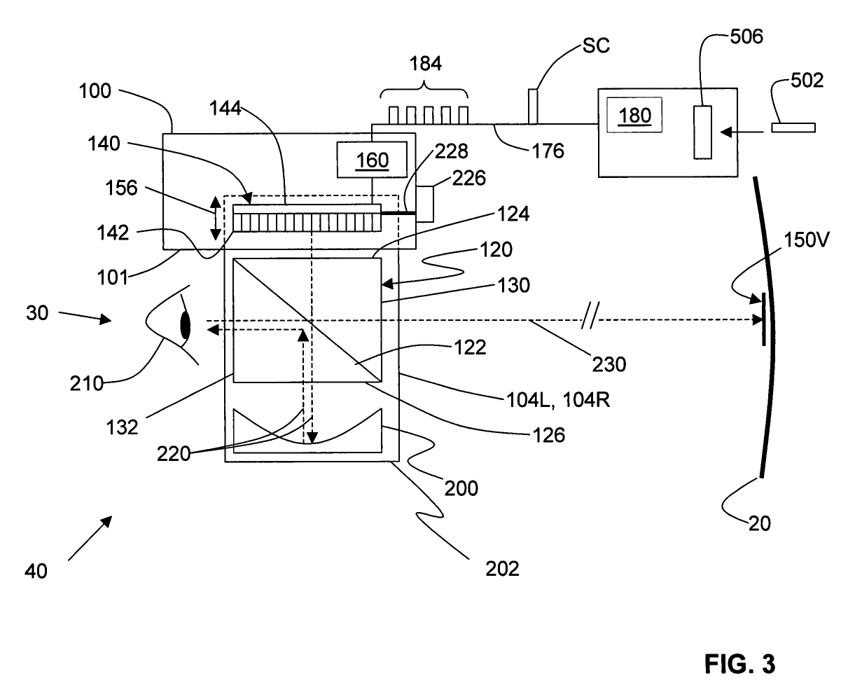

FIG. 3 is a close-up detailed side view of example embodiments of eyepiece 104L or 104R. Each eyepiece includes a beam splitter 120 with an internal beam splitting surface 122, an upper surface 124, a lower surface 126, a front surface 130 and a back surface 132. Each eyepiece also includes a flat-panel display (FPD) 140 (140L for the left eyepiece and 140R for the right eyepiece, FIG. 2). FPD 140 is arranged adjacent and parallel to beam splitter upper surface 124. FPD 140 is movable relative to upper surface 124 (arrow 156, FIG. 2). FPD 140 has an array of individually addressable pixels 142, and a backlighting unit 144 operably coupled to the pixel array to provide the illumination for the FPD.

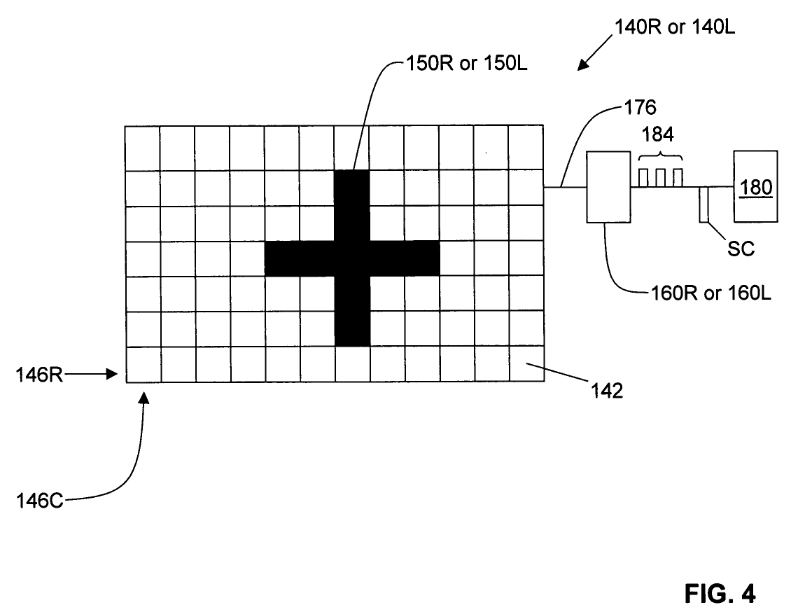

FIG. 4 is a plan view of an FPD 140 (140L or 140R) showing pixel rows 146R and pixel columns 146C. An example image 150 (150R or 150L) in the form of a cross is shown formed on the FPD by activating (i.e., addressably selecting) the appropriate pixels. A typical FPD 140 may have, for example, a 1024×1024 array of pixels 142.

With reference again also to FIGS. 2 and 3, FPDs 140L and 140R are operably coupled (e.g., via wiring 176) to respective video electronics units 160L and 160R, which, in turn, are operably coupled (e.g., via wiring 176) to a single controller 180. In an example embodiment, video electronics units 160L and 160R are incorporated into controller 180 (FIG. 2). Controller 180 is adapted to provide a video signal (“video stream”) 184 to video electronics units 160L and 160R, which process the video stream and deliver the video information to corresponding FPDs 140L and 140R. For example, video stream 184 provides data for image(s) 150L and 150R to video electronics units 160L and 160R. Each video electronics unit identifies the pixels 142 in pixels rows 146R and pixel columns 146C to be activated to form the image(s) in the corresponding FPD.

An example of a suitable controller 180 is one of the PRISM™ family of visualization systems from Silicon Graphics, Inc., of Mountain View, Calif.

With reference to FIG. 3, eyepieces 104L and 104R each include a curved mirror 200 arranged adjacent and parallel to beam splitter lower surface 126. In an example embodiment, beam splitter 120, FPD 140 and prism 120 are held in an eyepiece housing 202 that is movably engaged with housing 100 at or through lower surface 101 of housing 100.

Eyepiece Operation

With continuing reference to FIG. 3, eyepieces 140L and 140R operate as follows. First, the eyes 210 of user 30 are positioned adjacent back surfaces 132 of beam splitters 120. Controller 180 then provides video signal 184 to video electronics units 160L and 160R, which then provide video signals S140L and S140R to the respective FPDs 140L and 140R so as to form thereon the corresponding images 150L and 150R for each eyepiece. Images 150 form combined (i.e., registered) “virtual object” 150V (discussed in greater detail below) when imaged onto eyes 210 via the operation of each eyepiece mirror 200 and the reflection from each beam splitter interface 122, as indicated by optical path 220.

The focus adjustments for imaging virtual objects 150L and 150R to form the combined virtual object 150V at eyes 210 are made via left and right diopter adjustment mechanisms (“diopter adjusters”) 226L and 226R that are operably coupled to left and right FPDs 140L and 140R (e.g., via a mechanical link 228). Diopter adjusters 226L and 226R are adapted to move respective FPDs 140L and 140R relative to the corresponding beam splitter upper surface 124 (arrows 156, FIG. 3). Diopter adjusters 226L and 226R can be any one of a number of standard diopter adjusters known in the art. In an example embodiment, the diopter adjusters are or include a simple arrangement of a threaded lens barrel or cam inserted into a sleeve, the rotation of which causes an axial translation of the barrel. This arrangement may be manually operated, or motorized with a simple gear or pulley system as is standard in the art.

Method of Operation of the AR System

In the operation of AR system 10, user 30 views screen 20 via the optical path 230, which starts from the eye, passes directly through beam splitter 20—i.e., from back surface 32, straight through the beam splitter interface 122 and then through the beam splitter front surface 30—and then to the screen. This allows the user to see images 150L and 150R as a single registered image (“virtual object”) 150V that appears at the screen.

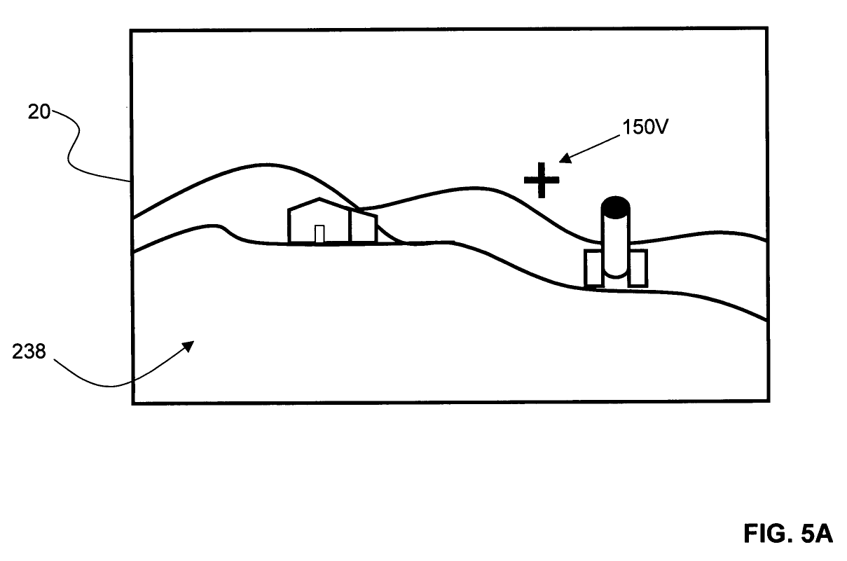

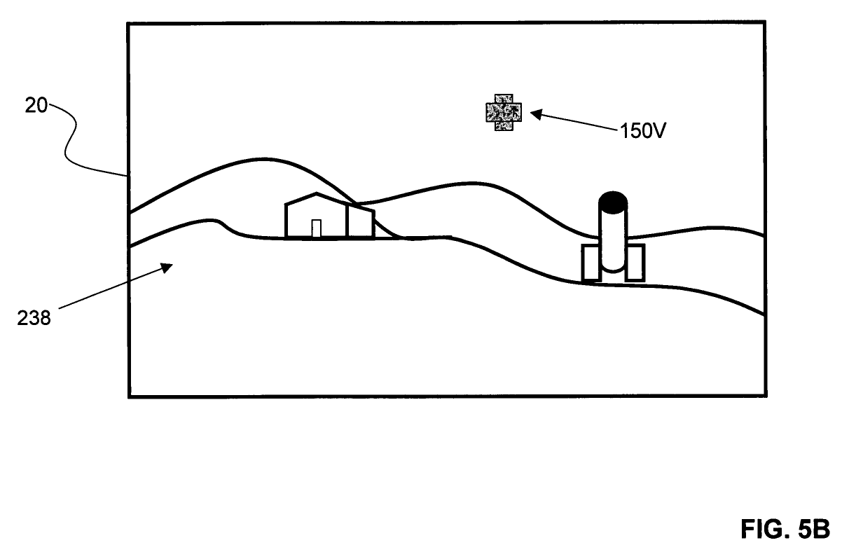

FIG. 5A is a front-on view of screen 20 having landscape scenery 238 formed thereon. Virtual object 150V is in the form of a cross, and is formed by the operation of left and right eyepieces 104L and 104R as described above when provided with left and right FPD images 150L and 150R each in the form of a cross. Virtual object 150V appears in focus on screen 20 when the vergence for eyepieces 104L and 104R and the diopter focus is correct for the position of the user relative to the screen.

FIG. 5B is a view similar to FIG. 5A, except that the user has moved his/her head so that the vergence has changed. This causes virtual object 150V to appear out of focus and not residing in the same focus plane as landscape scenery 238 on screen 20.

Vergence and IPD Control

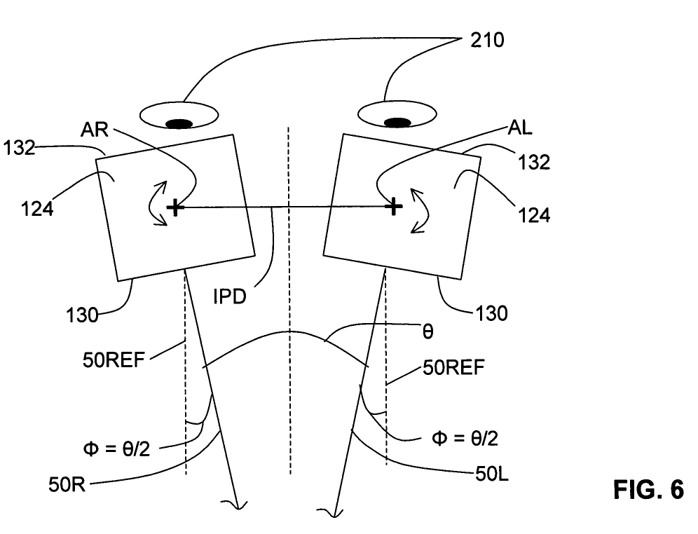

Eyepieces 104L and 104R are mechanically adjustable to control the focus (via diopter adjusters 226L and 226R) as well as the vergence and the IPD. FIG. 6 is a plan schematic diagram of eyepieces 104L and 104R that illustrate the vergence as angle θ, the IPD, and the rotation angle φ of the eyepieces. A change in rotation angle φ corresponds to a change in vergence. The rotation of the eyepieces occurs about respective eyepiece axes AL and AR that pass perpendicularly through upper and lower beam splitter surfaces 24 and 26 (FIG. 3).

The IPD is controlled by an IPD adjustment mechanism (“IPD adjuster”) 250 (FIG. 2) that uses any one of a number of known mechanisms to cause the eyepieces to move closer together or farther apart to suit a particular user's IPD.

Again referencing FIG. 2, a vergence adjuster 260 controls coarse adjustments to the vergence. The vergence adjuster is adapted to rotate eyepieces 104L and 104R over a rotation angle φ. Vergence adjuster 260 controls the angle of rotation φ between the lines-of-sight 50L and 5OR (which correspond to the surface normals of beam splitter surfaces 30) relative to a reference line of sight 50REF that corresponds to a vergence angle θ=0 (i.e., an object at infinity). The vergence angle is twice the rotation angle, i.e., θ=2φ).

However, as discussed in greater detail below, the present invention avoids the need to use mechanical vergence adjustment to maintain vergence while the user moves relative to the screen by electronically changing the positions of the images that form the virtual object being viewed.

Head Tracking Unit

Again referencing FIG. 2, ST-HMD 40 includes a head-tracking unit 350 that is adapted to continually provide controller 180 with the position and look-angle of the user's head as it is moved about while viewing screen 20 (FIG. 1) through eyepieces 104L and 104R. In an example embodiment, head-tracking unit 350 is coupled to controller 180 via wiring 176. In another example embodiment, head-tracking unit 350 includes a wireless transceiver 356 that communicates with controller 180 via wireless signals 360. In this wireless example embodiment, controller 180 also includes a wireless transceiver 366.

Examples of suitable head-tracking units include the LASERBIRD™ head-tracking device available from Ascension Technologies, of Burlington, Vt., and the LIBERTY™ and PATRIOT™ Head tracking devices available from Polhemus, Inc., of Colchester, Vt.

Method of Operation

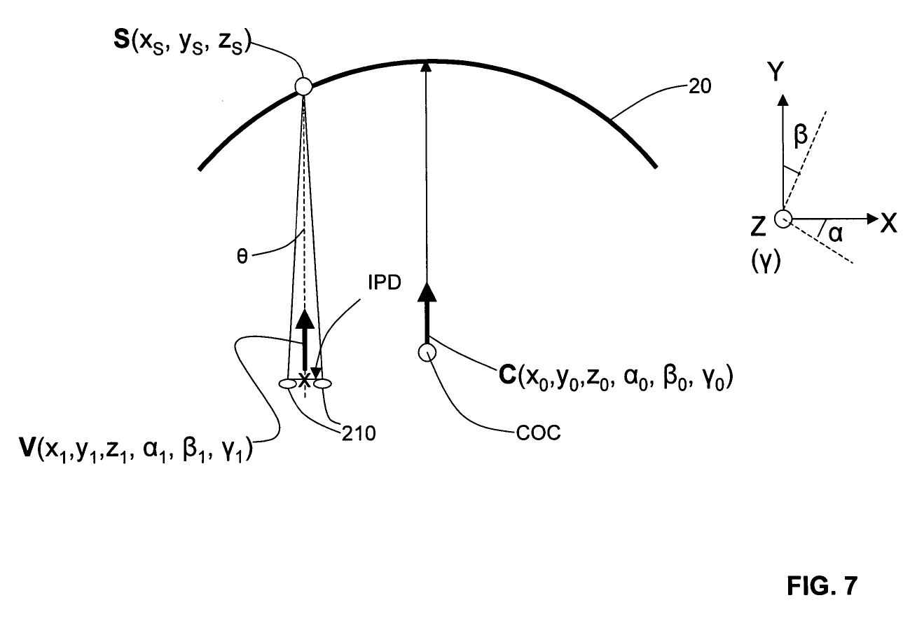

FIG. 7 is a schematic diagram illustrating the different parameters and vectors for AR system 10 that are used in carrying out example embodiments of the method of operation of the present invention. In FIG. 7, the position along screen 20 is given by S(x, y, z), the vergence by angle θ, and the IPD between left and right eyes 210 is as shown. Also defined is an “origin vector” C that points from the center of curvature COC of screen 20 to the screen itself is given by C(x₀, y₀, z₀, α₀, β₀, γ₀). Further, a viewing vector V=V(x1, y1, z1, α₁, β₁, γ₁) is defined that points from between the center of the user's eyes 210 to screen position S. The X, Y, Z coordinate axes and their corresponding rotation angles α, β, γ define the six degrees of freedom for the system.

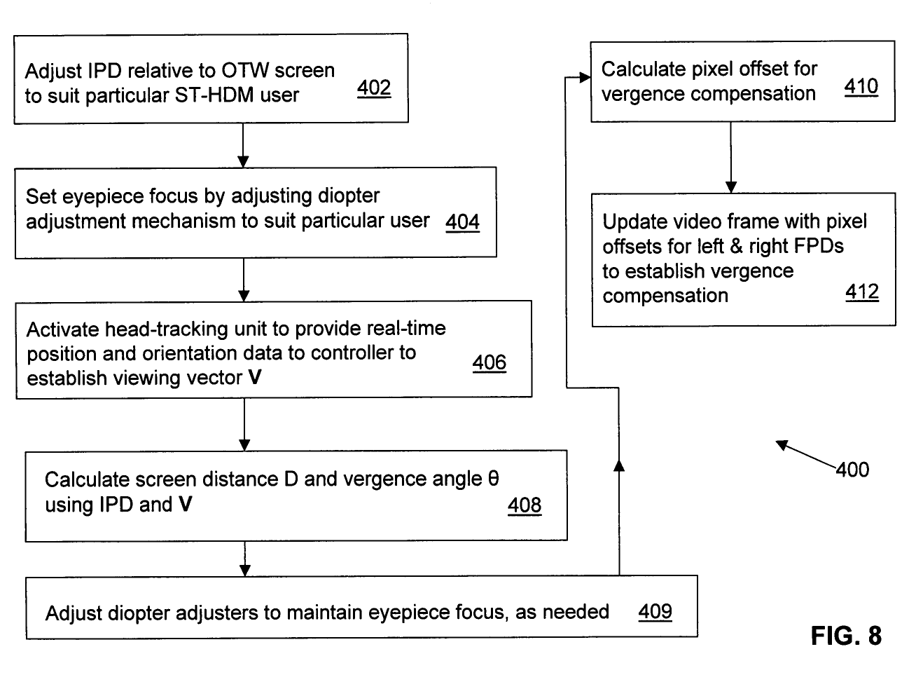

FIG. 8 is a flow diagram 400 of an example embodiment of a method of operation of ST-HMD system 40 as part of AR system 10 of FIG. 1. In the operation of ST-HMD 40, in act 402 user 30 dons the ST-HMD, and the IPD of eyepieces 104L and 104R is adjusted for the particular user by adjusting IPD adjuster 250 accordingly. The user's IPD value is preferably recorded (e.g., stored in controller 180) for later use. Typical military specifications require an IPD range of approximately 52-74 mm based on human physiology statistics. Once the IPD is set, it is assumed as a constant for the given user.

In act 404, the focus of each eyepiece 104L and 104R is adjusted as necessary (either manually or electronically) via diopter adjusters 226L and 226R.

The mechanical adjustments of the IPD and eyepiece focus in acts 402 and 404 are made in accordance with the distance D to screen 20 relative to user 30 being in a normal, “face forward” screen-viewing position, as shown in FIG. 1. Since the IPD affects the vergence, the vergence adjuster 260 should be designed with enough travel for the worst-case scenario of approximately 74 mm separation between the left and right eye pupil centers. The dioptric focus adjustment is also nominally set so that the ST-HMD images 150 as seen by the user when viewing screen 20 through the eyepieces are at an equivalent diopter setting to the screen distance D in the normal “face forward” position.

After the initial mechanical adjustments are made to ST-HMD 40, then in act 406, head-tracking unit 350 is activated to provide to controller 180 real-time data relating to the position and orientation of the user's head relative to screen 20 or to some other reference. Controller 180 uses this data to establish viewing vector V, which includes information about the distance D from user 30 to screen position S.

In act 408, using the IPD value and the viewing vector V established in act 406, controller 180 calculates the vergence for the position and orientation of ST-HMD 40 via the straightforward trigonometric calculation θ=2 TAN⁻¹([IPD]/2D).

In act 409, the focus for each eyepiece is adjusted as needed via the diopter adjusters 226L and 226R. In an example embodiment, this is carried out automatically via diopter control signals S226L and S226R sent from controller 180 to the respective diopter adjusters 226L and 226R.

In act 410, controller 180 calculates the offsets that need to be applied to video signal 180 by video electronics units 160L and 160R to provide real-time dynamic correction of vergence (“vergence correction”) as the user's head changes position. This is accomplished by changing the position of images 150L and 150R in FPDs 140L and 140R so that the viewer sees a single virtual object 150V as appearing in focus and at the proper vergence at screen point S.

The shift in images 150L and 150R is illustrated in FIG. 2. When the user moves his head away from screen point S, the images are shifted outwardly, as indicated by arrows 540O. Likewise, when user 30 moves his head toward screen point S, the images are shifted inwardly, as indicated by arrows 540I. In FIG. 2, pixels 142 from FPDs 140L and 140R are shown superimposed on the respective eyepieces to illustrate the compensating shifts in pixel location for images 150L and 150R.

In performing the shift in images 150L and 150R, in act 412, the video stream 184 is updated with pixel offsets for left and right FPDs 140L and 140R to establish the vergence compensation. This is accomplished by controller 180 carrying out an image-offset algorithm, discussed in greater detail below. The image-offset algorithm allows controller 180 to generate a vergence-correction signal SC and provide it to video electronics units 160L and 160R. The video electronics units receive the vergence-correction signal and execute the shifts in the position of images 150L and 150R in the corresponding FPDs 140L and 140R. The result is that the user sees image 150 as appearing in focus on screen 20 even as the user's head shifts position. Stated differently, the active vergence compensation ensures that the geometry of the viewing angle of the virtual objects (i.e., images 150) as seen through the ST-HMD 40 matches that of the real objects (e.g., object 50, FIG. 1) residing on (e.g., projected onto) screen 20

Image-Offset Algorithm

The vergence correction in acts 410 and 412 is achieved by an image-offset algorithm programmed into and carried out by controller 180. In an example embodiment, the pixel-offset algorithm is provided to controller 180 as a set of instructions embodied in a tangible medium 502, e.g., as software stored on a computer storage device 506, such as hard-drive. The image-offset algorithm uses the data from head-tracking unit 350 (e.g., via signal and calculates the correct offsets for the eyepiece images based on the known screen distance D and viewing vector V, which is also assigned an IPD value that is unique to an individual user's physiology.

Initially, the mechanical adjustments on the ST-HMD are set for an “average value” focus, IPD and vergence believed to be the most probable location of the user's head and viewing direction. These parameters are then adjusted as necessary via the left and right diopter adjusters 226L and 226R, the IPD adjuster 250 and the vergence adjuster 260, to match the particular user.

The viewing vector V may initially be assumed to be near origin vector C, but not necessarily coincident with C, and thus complex rotations and skew look angles need to be accounted for, as described below. The viewing vector V is determined from the data provided by head tracking system 350, which provides to controller 180 in real time the (x, y, z) coordinate position and the angles (α, β, γ) of the user's head. Angles (α, β, γ) in turn define the “look angle,” which corresponds to a given point S=S(x_{S}, y_{S}, Z_{S}) on the screen being viewed by the left and right eyes 210.

Once the screen viewing point S is known, then the distance D between V and S is easily determined, and is used to adjust the diopter setting of each eyepiece, as necessary. In addition to the focus offset, once the viewpoint vector V and the screen point S are known, the vergence θ between the left and right eyes 210 is calculated via the trigonometric relation between the IPD and the distance to the screen D, where θ=2 TAN⁻¹([IPD]/2D).

Once the vergence θ is determined, the electronic offset (pixel shift) for right and left images 150L and 150R for FPDs 140L and 140R is accomplished by adjusting the pixel rows 146R and pixel columns 146C that form the images. The adjustment offsets the entire image in each FPD 140L and 140R for the left and right eyes, independently, by amounts that maintain the vergence of the virtual objects (images 150L and 150R) at screen point S. The offset of images 150L and 150R is illustrated in FIG. 2 by arrows 540L and 540R.

In an example embodiment, the image offset is considered in the horizontal direction only, where “horizontal” is defined by the line along which the IPD is measured. Since the ST-HMD is mounted to the user's head, it is assumed that the ST-HMD and eye position are relatively constant. The magnitude of the image offset is given by H, which is a function of the focal length (f) of eyepieces 104L and 104R, and is defined by H=(f)Tan(θ). The image offset distance H may be quantized into the nearest integer pixel dimension to avoid the need for interpolating the entire video frame. In an example embodiment, this entire process is completed at least once within the frame time of one video cycle for video stream 184, whose cycle is typically 60 Hz.

In an example embodiment, the image-shifting algorithm includes sampling the viewpoint position several times within one video frame time, thus allowing an additional processing step that involves a prediction algorithm that estimates where the viewpoint will be when the next video frame appears.

Eye-Tracker Embodiment

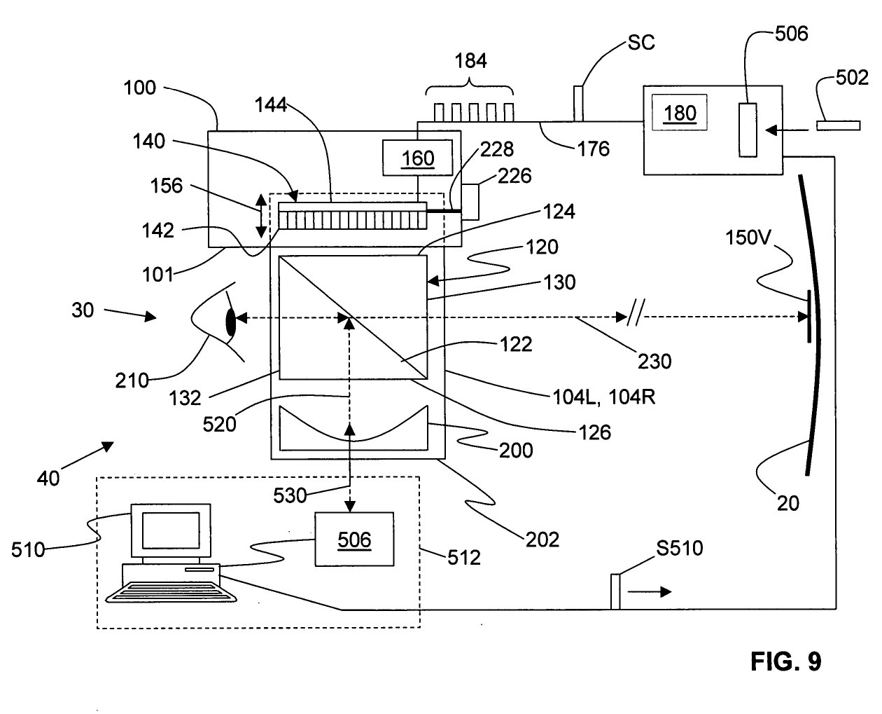

FIG. 9 is a schematic diagram similar to FIG. 3, but that additionally includes eye-tracker optics 506 coupled to an eye-tracker controller 510. Eye-tracker optics 506 and eye-tracker controller 510 collectively constitute an eye-tracking system 512. Eye-tracker controller 510 is operably coupled to controller 180 so that eye tracking information (data) can be transferred from the eye-tracker controller to controller 180 via a signal S510.

Eye-tracker optics 506 are optically coupled to one or both eyes 210 via an optical path 520. In the example embodiment illustrated in FIG. 9, mirror 200 is partially transmits infra-red light to allow for optical path 520 to pass through the mirror and to beam splitter 120, which serves to fold the optical path. In operation, eye-tracker optics 506 provide infra-red light 530 that travels along the optical path to eye(s) 210. Infra-red light reflects off eye(s) 210 and returns to the eye-tracker optics nominally over the optical path. Deviations in the optical path 520 from a reference path (e.g., a “looking straight ahead” path) caused by movement of the eye are detected by eye-tracker optics 506 and processed by eye-tracker controller 510. The deviations in the optical path are translated into a pointing direction by software in the eye-tracker controller and provided to controller 180 via signal S510. The eye tracking system, combined with the head tracking unit, effectively creates two separate viewpoint vectors, V_{L} and V_{R}, which are used to further refine the independent left and right dynamic pixel offset values.

In an example embodiment, eye-tracking system 512 is or includes a version of a commercially available system, such as that manufactured by Arrington Research, Inc., of Scottsdale, Ariz. In an example embodiment, eye-tracker optics 506 utilize the existing eyepieces 104L and 104R, as described above in connection with FIG. 3. Integration of the eye tracker to eyepieces 104L and 104R involves a simple modification of mirror 200 to change its reflective coating to reflect only visible light while transmitting the infra-red light. This is accomplished by coating technology similar to that used in “Hot Mirrors” employed in medical instruments, as is known by those skilled in the art of mirror coatings.

In an alternative example embodiment of eye-tracking system 512, the “see-through” path 230 of the eyepiece offers another optical path through which the eye tracker optics' infra-red beam 530 may pass.

Once the eye-tracking data is taken, it is transferred to controller 180 via signal S510 and read into the vergence processing algorithm stored therein to refine the calculations of actual screen distance to the point of observation and the actual vergence angle between the two eyes.

Adjustment of Dynamic Focus

If the screen distance D is relatively small and dynamic focus adjustment is required, then in an example embodiment, left and right diopter adjusters 250L and 250R are automatically adjusted via diopter control signals S226L and S226R provided by controller 180. All the dynamic electronic corrections are controlled by controller 180, which provides a data rate fast enough that the offsets occur imperceptibly to the user. This provides for a smooth overlay of the ST-HMD virtual object 150V (formed from left and right eyepiece images 150L and 150R) with the imagery on screen 20.

For the purposes of explanation, specific embodiments of the invention are set forth above. However, it will be understood by one skilled in the art, that the invention is not limited to the specific example embodiments but rather by the appended claims. Moreover, well-known elements, process steps, and the like, and including, but not limited to, optical components, electronic circuitry components and connections, are not set forth in detail in order to avoid obscuring the invention.

What is claimed is:

1. A method of compensating for changes in vergence of a virtual object as seen by a user viewing a real object through a see-through head-mounted display (ST-HMD) system having movable left and right eyepieces set to an interpupilary distance (IPD) of the user, the method comprising:
providing tracking information to a controller by tracking movements of the ST-HMD that cause a change in the vergence;
calculating from the tracking information a viewing vector of the ST-HMD relative to a position on the real object;
calculating from the viewing vector and the IPD a new vergence and a distance D from the ST-HMD to the real object; and
offsetting the virtual object in the right and left eyepieces so that the user sees the virtual object on the real object with the new vergence.

2. The method of claim 1, wherein the left and right eyepieces include corresponding left and right flat panel displays each having a plurality of addressable pixels that support corresponding left and right images that are adapted to be viewed by the user as the virtual object, and wherein said offsetting includes shifting the left and right images in the flat panel display to establish the new vergence.

3. The method of claim 1, wherein the real object is a screen.

4. The method of claim 1, wherein providing tracking information includes providing eye-tracking information of one or more eyes of the user.

5. A method of maintaining vergence in an augmented reality (AR) system having a screen and a see-through head-mounted display (ST-HMD) worn by a user, the method comprising:
generating left and right virtual objects in corresponding left and right eyepieces of the ST-HMD so that the user can see a registered virtual object when viewing the screen through the eyepieces;
tracking movement of the ST-HMD as the user views the registered virtual object on the screen;
calculating a vergence for the ST-HMD based on the tracked movements; and
adjusting the left and right virtual objects to maintain vergence so that the user sees the registered virtual object on the screen even if the ST-HMD moves relative to the screen.

6. The method of claim 5, wherein each eyepiece includes a corresponding flat panel display (FPD) comprising a plurality of addressable pixels, and wherein the eyepieces are adapted to support an image on each FPD that is viewable through the respective eyepieces as the registered virtual image, and wherein said adjusting includes:
shifting the image on each FPD by a select amount of pixels.

7. The method of claim 6, wherein the FPD images are provided to each FPD as a video stream from a controller.

8. The method of claim 5, including automatically adjusting a focus of each eyepiece to maintain focus at the screen.

9. The method of claim 5, wherein providing tracking information further includes providing eye-tracking information.

10. A see-through head-mounted display (ST-HMD) system capable of compensating for changes in vergence of the ST-HMD relative to a real object, comprising:
left and right eyepieces having corresponding left and right flat panel displays (FPDs) having corresponding array of pixels that are selectively addressable to support corresponding left and right images, the eyepieces being adapted for a user to view the left and right images as a registered virtual object when viewing the real object;
left and right video electronics units respectively operably coupled to the left and right FPDs and adapted to provide to the left and right FPDs respective left and right video electrical signals representative of the left and right images;
a controller operably coupled to the left and right video electronics and adapted to provide the left and right video electronics with a video stream of the left and right images;
a head-tracking unit adapted to provide information about the user's position while viewing the registered virtual object at the real object; and
wherein the controller is adapted to calculate, based on the user's position information, a shift in the position of the left and right images on the respective left and right FPDs and provide a correction signal representative of same to the left and right video electronics units to effectuate the image shift so as to maintain vergence of the registered virtual object at the real object as viewed by the user.

11. The system of claim 10, further including an eye-tracking system adapted to track eye movements of eyes of the user and provide eye-movement data to the controller.

12. The system of claim 10, wherein the real object is a screen.

13. A see-through head-mounted display (ST-HMD) system that allows a user to view a virtual object at a real object with substantially constant vergence, comprising:
a housing adapted to support the ST-HMD on the user's head;
right and left eyepieces operably coupled to the housing and positioned so as to provide the user with a view of the real object through the eyepieces, the eyepieces being adapted to provide respective left and right images that when viewed by the viewer form the virtual object;
a head tracking unit adapted to provide position information of the ST-HMD as the user views the real object; and
a controller operably coupled to the head tracking unit and the right and left eyepieces and adapted to effectuate a shift in the left and right images to compensate for changes in vergence due to movement of the user.

14. The system of claim 13, further including:
left and right video electronics operably coupled to the controller;
left and right flat panel displays (FPDs) in the respective left and right eyepieces, the left and right FPDs electronically coupled to the left and right video electronics, respectively; and
wherein the left and right video electronics provide the respective left and right FPDs with respective left and right video electronic signals to effectuate said shift the left and right images.

15. The system of claim 13, further including:
left and right diopter adjusters operably coupled to each eyepiece and to the controller and adapted to adjust the focus for the respective eyepieces in response to a corresponding control signal from the controller.

16. The system of claim 13, wherein the real object is a screen onto which a real image is projected.
